(19) United States
(12) Patent Application Publication
(10) Pub. No.: US 2017/0090013 A1
(43) Pub. Date: Mar. 30, 2017

(54) APPARATUS AND METHOD FOR ATTENUATING CLOSE-RANGE RADAR SIGNALS IN AN AUTOMOTIVE RADAR SENSOR

(71) Applicant: Autoliv ASP, Inc., Ogden, UT (US)

(72) Inventors: Michael Paradie, Hollis, NH (US); Dirk Klotzbuecher, Mainstockheim (DE); Walter Poiger, Bad Neustadt (DE); Matthew Douglas Marple, Pepperell, MA (US); Olof Hugo Eriksson, Alvsjo (SE)

(73) Assignee: Autoliv ASP, Inc.

(21) Appl. No.: 14/870,226

(22) Filed: Sep. 30, 2015

(51) Int. Cl. G01S 7/292; G01S 13/93

(52) U.S. Cl. CPC G01S 7/2921; G01S 13/931; G01S 2013/9332; G01S 2013/9389

(57) ABSTRACT

A radar system and method include a first transmitted radar signal having a first frequency and a second transmitted radar signal having a second frequency different from the first frequency. A receiver receives reflected radar signals generated by reflection of the transmitted radar signals and generates receive signals indicative of the reflected radar signals, a first receive signal being indicative of a first reflected radar signal generated by reflection of the first transmitted radar signal, and a second receive signal being indicative of a second reflected radar signal generated by reflection of the second transmitted radar signal. A processor receives the first and second receive signals and computes a difference between the first and second receive signals to generate a difference signal, the processor processing the difference signal to provide radar information.

### BACKGROUND

1. Technical Field

The present disclosure is related to automotive radar systems and, in particular, to an apparatus and method for attenuating close-range radar signals in an automotive radar sensor.

2. Discussion of Related Art

In automotive radar systems, the radar sensor can be mounted, i.e., physically attached, to the vehicle body or frame. Alternatively, the sensor can be mounted to the bumper fascia. Radar system performance is typically characterized based on the ability of the automotive radar system to detect objects and correctly determine their range, bearing and Doppler velocity. For radar processing purposes, it is often preferred that the sensor be mounted to the bumper fascia instead of the vehicle frame or body. This is because, when the sensor is mounted to the fascia, radar system performance is typically better because the radar sensor and fascia vibrate together, i.e., they are synchronized and in phase. As a result, the radar sensor sees the fascia as being stationary, i.e., at a constant distance, with respect to the radar sensor. The fascia is processed by the radar as a constant signal. As such, the signal due to the return from the fascia can be easily removed from the radar signal before further processing.

Some automobile manufacturers, however, prefer that the radar sensor be mounted on the body to enhance ease of assembly, or for other reasons. In that configuration, i.e., with the radar sensor mounted on the body or frame, radar system performance can be degraded by vibration, since movement of the fascia is not synchronized to movement of the sensor. Instead of the constant fascia signal, movement of the fascia relative to the sensor due to vibration appears as a time-varying signal, which can be difficult to remove from the radar signal. Incomplete removal of the fascia signal degrades the ability of the radar to detect objects and/or correctly estimate object parameters.

### SUMMARY

According to one aspect, a radar system is provided. The radar system includes a radar signal transmitter for transmitting transmitted radar signals into a region, a first transmitted radar signal having a first frequency and a second transmitted radar signal having a second frequency different from the first frequency. A receiver receives reflected radar signals generated by reflection of the transmitted radar signals and generates receive signals indicative of the reflected radar signals. A first receive signal is indicative of a first reflected radar signal generated by reflection of the first transmitted radar signal, and a second receive signal is indicative of a second reflected radar signal generated by reflection of the second transmitted radar signal. A processor receives the first and second receive signals and computes a difference between the first and second receive signals to generate a difference signal. The processor processes the difference signal to provide radar information for the region.

In some exemplary embodiments, a difference between the first frequency and the second frequency is selected such that the information related to objects in the region near the radar system is attenuated in the difference signal. In some exemplary embodiments, a difference between the first frequency and the second frequency is selected such that a phase difference between the first and second reflected radar signals is such that information related to objects in the region near the radar system is attenuated in the difference signal.

In some exemplary embodiments, the first frequency is approximately 24.2 GHz. In some particular exemplary embodiments, a difference between the first frequency and the second frequency is approximately 11 MHz.

In some exemplary embodiments, the transmitted radar signals are pulse radar signals. In some particular exemplary embodiments, a pulse of the pulse radar signals has a duration of approximately 120 nsec.

In some exemplary embodiments, the radar system is an automotive radar system. A difference between the first frequency and the second frequency can be selected such that information related to objects in the region near the radar system is attenuated in the difference signal. The objects in the region near the radar system can include a bumper fascia of an automobile in which the radar system is disposed. A difference between the first frequency and the second frequency can be selected such that a phase difference between the first and second reflected radar signals is such that information related to objects in the region near the radar system is attenuated in the difference signal. The radar system can be an automotive blind spot radar system.

According to another aspect, a detection method in a radar system is provided. According to the method, transmitted radar signals are transmitted into a region, a first transmitted radar signal having a first frequency and a second transmitted radar signal having a second frequency different from the first frequency. Reflected radar signals generated by reflection of the transmitted radar signals are received. Receive signals indicative of the reflected radar signals are generated. A first receive signal is indicative of a first reflected radar signal generated by reflection of the first transmitted radar signal, and a second receive signal is indicative of a second reflected radar signal generated by reflection of the second transmitted radar signal. A difference between the first and second receive signals is computed to generate a difference signal. The difference signal is processed to provide radar information for the region.

In some exemplary embodiments, the method further comprises selecting a difference between the first frequency and the second frequency such that information related to objects in the region near the radar system is attenuated in the difference signal. In some exemplary embodiments, the method further comprises selecting a difference between the first frequency and the second frequency such that a phase difference between the first and second reflected radar signals is such that information related to objects in the region near the radar system is attenuated in the difference signal.

In some exemplary embodiments, the first frequency is approximately 24.2 GHz. In some particular exemplary embodiments, a difference between the first frequency and the second frequency is approximately 11 MHz.

In some exemplary embodiments, the transmitted radar signals are pulse radar signals. In some particular exemplary embodiments, a pulse of the pulse radar signals has a duration of approximately 120 nsec.

In some exemplary embodiments, the radar system is an automotive radar system. A difference between the first frequency and the second frequency can be selected such that information related to objects in the region near the radar system is attenuated in the difference signal. The objects in the region near the radar system can include a bumper fascia of an automobile in which the radar system is disposed. A difference between the first frequency and the second frequency can be selected such that a phase difference between the first and second reflected radar signals is such that information related to objects in the region near the radar system is attenuated in the difference signal. The radar system can be an automotive blind spot radar system.

### BRIEF DESCRIPTION OF THE DRAWINGS

The present disclosure is further described in the detailed description which follows, in reference to the noted plurality of drawings by way of non-limiting examples of embodiments of the present disclosure, in which like reference numerals represent similar parts throughout the several views of the drawings.

FIG. 1 includes a schematic block diagram of an automotive radar sensor module for processing automotive radar signals, in accordance with some exemplary embodiments.

FIG. 2 includes a schematic top view of an automobile or vehicle equipped with a radar system, which includes one or more radar sensor modules, according to some exemplary embodiments.

FIG. 3 includes a schematic timing diagram which illustrates exemplary timing of the radar processing to attenuate near-range objects, according to some exemplary embodiments.

FIG. 4 includes a logical flow diagram illustrating the logical flow of the radar processing to attenuate near-range objects, according to some exemplary embodiments.

FIG. 5 is a graph of suppression (attenuation) versus range bin in the automotive radar system, according to some exemplary embodiments.

### DETAILED DESCRIPTION

According to the exemplary embodiments of the present disclosure, provided is an automotive radar system in which the undesirable effects of objects appearing at a particular predetermined range are removed from the radar signal. For example, the effects contributed to the radar signal by the bumper fascia of the host vehicle, which may generate a near-range time-varying signal due to vibrations and other movement relative to the radar sensor, can be eliminated. This results in substantially improved radar system performance characterized by substantial improvement in the ability of the automotive radar system to detect objects and correctly determine their range, bearing and Doppler velocity. According to the exemplary embodiments, the system of the disclosure eliminates or substantially reduces these undesirable effects by substantially or completely attenuating the signal at the range at which the object producing the signal, e.g., the bumper fascia, is located. The technique is also effective at removing any signal that is due to an object that is physically very close to the sensor, e.g., rain spray, reflection from rotating tire(s), etc. The technique of the current disclosure can also be used to attenuate signals at any predetermined range from the sensor.

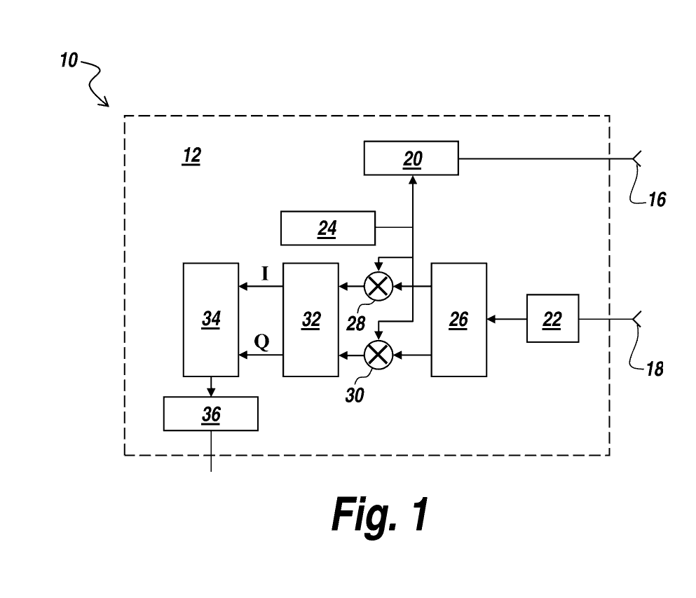

FIG. 1 includes a schematic block diagram of an automotive radar system 10, including one or more radar sensor modules 12 for processing automotive radar signals, in accordance with some exemplary embodiments. Referring to FIG. 1, system 10 includes one or more radar modules 12, which process radar transmit and receive signals which are compatible with the radar detection and monitoring system 10 in the host automobile. Radar module 12 generates and transmits radar signals into the region adjacent to the host vehicle that is being monitored by the radar system. Generation and transmission of signals is accomplished by RF signal generator 24, radar transmit circuitry 20 and transmit antenna 16. Radar transmit circuitry 20 generally includes any circuitry required to generate the signals transmitted via transmit antenna 16, such as pulse shaping/timing circuitry, transmit trigger circuitry, RF switch circuitry, or any other appropriate transmit circuitry used by radar system 10.

Radar module 12 also receives returning radar signals at radar receive circuitry 22 via receive antenna 18. Radar receive circuitry 22 generally includes any circuitry required to process the signals received via receive antenna 18, such as pulse shaping/timing circuitry, receive trigger circuitry, RF switch circuitry, or any other appropriate receive circuitry used by the radar system. The received signals processed by radar receive circuitry 22 are forwarded to phase shifter circuitry 26, which generates two signals having a predetermined phase difference. These two signals, referred to as an inphase (I) signal and a quadrature (Q) signal, are mixed with an RF signal from RF signal generator 24 by mixers 28 and 30, respectively. The resulting difference signals are further filtered as required by filtering circuitry 32 to generate baseband I and Q signals, labeled “I” and “Q” in FIG. 1. The baseband I and Q signals are digitized by analog-to-digital converter circuitry (ADC) 34.

In automotive radar systems, these digitized I and Q baseband signals are processed by a processor, such as a digital signal processor (DSP) 36. In some exemplary embodiments, the DSP 36 can perform processing such as signal subtraction and/or Fast Fourier Transform (FFT) processing to generate a plurality of range bins processed according to the detailed description herein to attenuate close-range radar signals to improve performance of radar system 10. In one particular embodiment, radar system 10 is a blind spot radar system used to detect and/or identify objects in a blind spot of a host automobile.

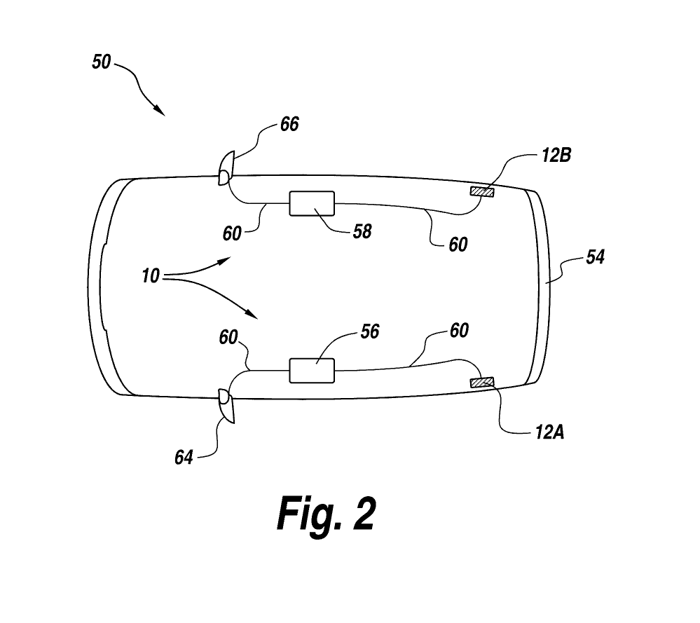

FIG. 2 includes a schematic top view of an automobile or vehicle 50 equipped with radar system 10, which includes one or more radar sensor modules 12. In the particular embodiment illustrated in FIG. 2, radar system 10 is a blind spot system for reporting object detections in one or both blind spots of automobile 50. It will be understood that the present disclosure is applicable to other types of radar systems 10. A first radar sensor module 12A is connected via a bus 60, which in some exemplary embodiments is a standard automotive controller area network (CAN) bus, to a first CAN bus electronic control unit (ECU) 56. Object detections from radar sensor module 12A are reported to ECU 56, which processes the detections and provides detection alerts via CAN bus 60. In some exemplary embodiments, the alerts can be in the form of a visible indicator, such as a light-emitting diode (LED) in side minor 64, which is visible to the driver. Similarly, in some exemplary embodiments, a second radar sensor module 12B is connected via CAN bus 60, to a second CAN bus electronic control unit (ECU) 58. Object detections from radar sensor module 12B are reported to ECU 58, which processes the detections and provides detection alerts via CAN bus 60 to a visible indicator, such as a light-emitting diode (LED) in side minor 66.

According to the exemplary embodiments, during normal radar detection processing, radar sensor modules 12 operate by transmitting pulse radar signals in a sweep configuration into the region around vehicle 50. In some particular exemplary embodiments, given the application of system 10 to automotive radar, the range of system 10 can be, for example, approximately 13.0 meters. This total range is divided into a plurality of range increments, which are respectively associated with a plurality of range “bins.” During radar detection processing, in some exemplary embodiments, at each increment, a plurality of transmit radar pulses is transmitted from sensor modules 12. The radar receiver “opens” to receive returning radar signals, as defined by the range particular range bin. The returning signals at each range are subject to an integration period during which the radar receive signals are sampled and held. At the end of the integration period for each range, the accumulated sampled and held receive signal is stored as the data in that range bin. The range for the next data collection period is then incremented, and the process repeats to generate data for the next range bin. This process continues until data is collected for all of the range increments in the total range of interest. In some particular exemplary embodiment, 256 range increments are used, having a range differential of approximately 0.05 meter, for a total maximum range of approximately 13.0 meters.

According to the present disclosure, to eliminate the undesirable effects of near-range objects, such as, for example, the bumper fascia 54 of vehicle 50, the receive signals for close ranges are substantially attenuated. According to the exemplary embodiments, this is accomplished by transmitting at least two sets of radar pulse signals at each range and generating the receive signal data for each range bin using a combination of the receive signals generated in response to the two sets of transmit signals for the range. Specifically, according to some exemplary embodiments, within each range increment, a first transmit pulse at a first frequency f1 is transmitted. Returns such as reflected signals are received and stored for this transmit pulse during a first receive period determined by the activation of a receive pulse or receive gate. Next, a second transmit pulse at a second frequency f2 is transmitted. Returns associated with this second transmit pulse are received and stored during a second receive period determined by the activation of a second receive pulse or receive gate. In some exemplary embodiments, at each range increment, this process of transmitting radar illumination pulses at frequencies alternating in frequency between f1 and f2, and receiving and storing return data for each transmit pulse can be repeated for the purpose of, for example, improving signal-to-noise ratio (SNR). In one particular exemplary embodiment, during each range increment 29 pairs of illumination pulses are transmitted, alternating in frequency between f1 and f2. Alternatively, in other particular exemplary embodiments, 29 pulses at a first frequency f1 are transmitted followed by 29 pulses at a second frequency f2. Then, according to exemplary embodiments, for each range increment, a complex subtraction is performed between the two generated receive signals to generate the actual receive signal data for the range increment. This difference signal is then processed instead of one of the actual receive signals to perform object detection.

According to the exemplary embodiments, the difference in transmit frequencies causes a phase difference between the associated receive signals. When the complex subtraction of the signals is performed, the signals with the smallest phase difference are effectively eliminated, since the direct subtraction of the similar signals results in a very small resulting signal. Understanding that the signals from the smallest, i.e., closest, ranges will have the smallest phase difference, because of the relatively small round-trip return time of the radar signals, the effect of the approach of the disclosure is to attenuate the near-range signals. Thus, in the case of, for example, the bumper fascia, or other near-range objects, the receive signals are so substantially attenuated as to be effectively eliminated from the object detection radar processing.

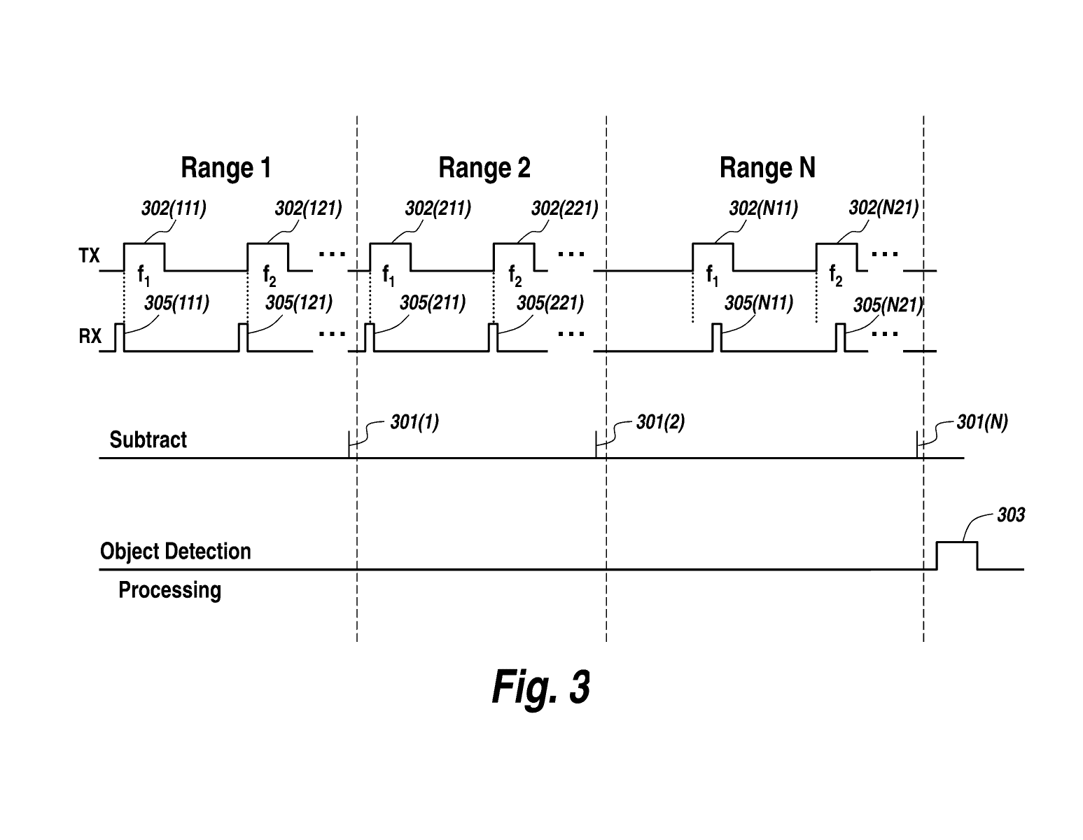

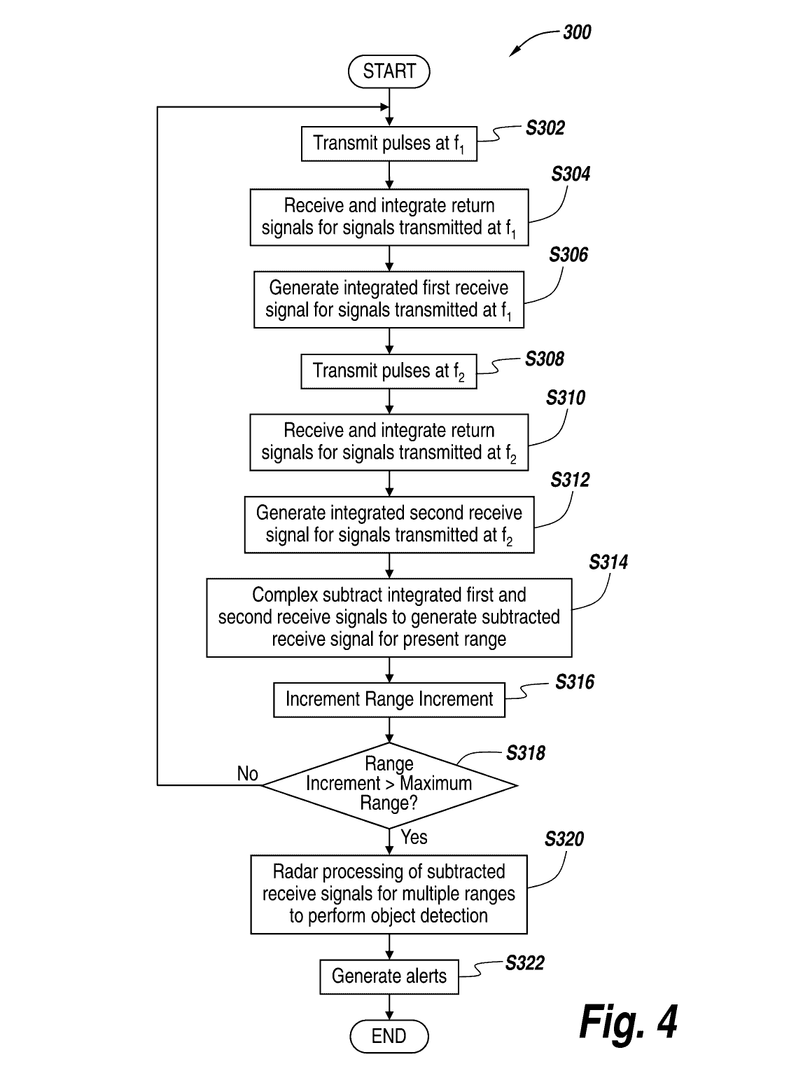

FIG. 3 includes a schematic timing diagram which illustrates exemplary timing of the radar processing to attenuate near-range objects, according to some exemplary embodiments. FIG. 4 includes a logical flow diagram illustrating the logical flow of the radar processing to attenuate near-range objects, according to some exemplary embodiments. In the timing diagram of FIG. 3, the first curve illustrates exemplary timing of exemplary illuminating transmit pulses, the second curve illustrates exemplary timing of exemplary receive and integration processing, the third curve indicates exemplary timing of complex subtraction of the integrated receive signals, and the fourth curve indicate exemplary object detection radar processing on the subtracted receive signals for multiple range increments.

Referring to FIGS. 3 and 4, in step S302, for the first range, i.e., Range 1, an illuminating radar pulse is transmitted at a first frequency f1, as indicated by 302(111), where, by convention used herein, the first number in parentheses indicates range increment 1, the second number in parentheses indicates frequency number 1, and the third number in parentheses indicates the number of the pair of transmit pulses. Although not illustrated in FIG. 3, this third number would run in a range from 1 to the number of repetitions of the f1/f2 transmit pairs, which, as noted above, in one particular exemplary embodiment, is 29. Returns are received and integrated in step S304 for the first transmit pulse in the first range, i.e., 302(111), as indicated by active receive signal or receive “gate” 305(111). As indicated in step S306, an integrated first receive signal for the signal transmitted at f1 is generated. Next, as indicated in step S308, for the first range increment, i.e., Range 1, radar pulse 302(121) is then transmitted at second frequency f2. Returns are received and integrated in step S310 for the second transmit pulse 302(121) in the first range increment as indicated by active receive signal or receive “gate” 305(121). As indicated in step S312, an integrated second receive signal for the signal transmitted at f2 is generated.

As described above, steps S302 through S312 can be repeated any number of times within the present range increment, e.g., Range 1. As described above, in some particular exemplary embodiments, these steps are repeated 29 times for each range increment to generate integrated first and second receive signals.

Next, as indicated in step S314 and by pulse 301(1) in FIG. 3, the integrated first and second receive signals are subtracted to generate a subtracted receive signal for the current range increment, i.e., Range 1. Generally, the subtraction is a complex subtraction of complex numbers. As indicated in step S316, the range increment number is incremented, e.g., to Range 2, and, in decision step S318, the range increment is checked to determine whether the maximum range of interest being processed has been reached. If not, then flow returns to step S302, and the process of steps S302 through S318 is repeated for the next range increment, i.e., Range 2. That is, two sets of transmit pulses are transmitted at frequencies f1 and f2 in Range 2, and return signals are received and integrated as illustrated by receive active signals or receive gates 305(211) and 305(221). Subtraction is performed at 301(2) for range increment Range 2.

The above process continues until the entire process is complete, i.e., a subtracted receive signal is generated for each range increment or bin in the total range of interest. That is, as illustrated in FIG. 3, the process continues until a subtracted receive signal for Range N is competed. This is referred to as a complete sweep of transmit pulses. After the complete sweep, in decision step S318, the present range will exceed the maximum range N, and flow continues to step S320. In step S320, radar processing of the subtracted receive signals for the multiple ranges is performed to provide object detection, as indicated by active object detection processing signal 303 in the timing diagram of FIG. 3. According to the exemplary embodiments, in contrast to prior systems, the radar object detection of step S320 is carried out with the effects of irrelevant near-range objects, such as, for example, the bumper fascia, removed and, therefore, not influencing radar object detection. In step S322, when relevant objects are detected, alerts are generated.

With reference to FIG. 3, it is noted that the different range increments are achieved by varying the time at which the receiver is opened up to receive and process returns, relative to the timing of the transmit pulses. That is, referring to FIG. 3, the timing of the active receiver periods or range “gates” 305 with respect to the transmit pulses is varied. By opening up the receiver period later, a longer range is being analyzed, due to the longer round-trip time of the signals being received and processed. However, because of the relatively long transmit pulses and the relatively short receive pulses, all returns will include information related to short-range targets, e.g., the bumper fascia. That is, all returns will be due to reflections from all objects between immediately adjacent to the radar unit out to the maximum range determined for the particular range increment, which is defined by the relative timing of the transmit and receive pulses. According to the disclosure, the complex subtraction of the returns due to the different transmit frequencies within a range increment attenuates the effects of these returns which are from close range objects.

According to the present disclosure, each transmit pulse is transmitted and possibly reflected off an object, and the reflected return is received before the next transmit pulse is transmitted. Hence, according to particular exemplary embodiments as illustrated in FIG. 3, the transmit pulses and receive pulses are interleaved, actually overlapping due to the length of the transmit pulses. According to the disclosure, the leading edge of each receive pulse is precisely timed with the leading edge of its respective associated transmit pulse in order to control the maximum range of object reflections what will be received in that range increment or bin. The transmit pulses are very long due to regulatory constraints. In some particular exemplary embodiments, the transmit pulses have a duration of approximately 120 ns. Also, the receive pulses are relatively very short and occurs during some portion of the time during which the associated transmit pulse is being transmitted. This configuration results in each range increment or bin having reflected energy from all objects at the maximum range of the bin in addition to all shorter ranges. That is, because of the relative time durations of the transmit pulses and their respective associated receive pulses, reflected energy from close-range objects such as the bumper fascia, appears in every range bin for the waveform being used. The present disclosure provides an approach to attenuating or eliminating the effects of this unwanted reflected energy from the radar object detection processing of the system.

In some particular exemplary embodiments, the total range of the system is approximately 13.0 meters, and each sweep includes 250 range increments or bins, i.e., N=256, resulting in approximately 0.05 meter/bin, and each receive active period or gate 305 opening at one of 256 unique delay times.

According to the disclosure, the radar sensor transmits the desired waveform twice. The first transmission uses the nominal radio frequency of the system, which in some particular exemplary embodiments, can be approximately 24.2 GHz. The second transmission is at a radio frequency offset up or down from the first frequency by some value, e.g., 11 MHz. According to the disclosure, the received signal from the first part can be subtracted from the received signal of the second part. Each signal is complex, so the resulting subtracted signal is also complex, having real and imaginary parts. The resulting complex subtracted signal is then processed with the same procedure of the original waveform of prior system, which would only be transmitted once, in order to perform object detection and parameter estimation.

Thus, the technique of the present disclosure creates attenuation of signals, where the attenuation depends on object range. In an ideal case, zero range has complete attenuation. Attenuation decreases as object range increases, up to a certain range which has no attenuation of signal energy. At the range where there is no attenuation of signal energy, the two signals actually add in phase, which can result in an improvement in signal-to-noise ratio (SNR), for example, a 3 dB improvement in SNR. In some exemplary embodiments, the range at which zero attenuation occurs depends on the frequency offset of the first and second waveform parts, i.e., sets of transmit pulses. This is because the slight difference in frequency causes a difference in phase of the returning signals. This phase difference is range-dependent. Close-range signals will have smaller path-length difference, and, therefore, less phase difference. As a result, when the subtraction is performed, the signal exhibits greater attenuation. For example, an offset of approximately 11 MHz can be used to achieve zero attenuation at approximately 6.8 meters.

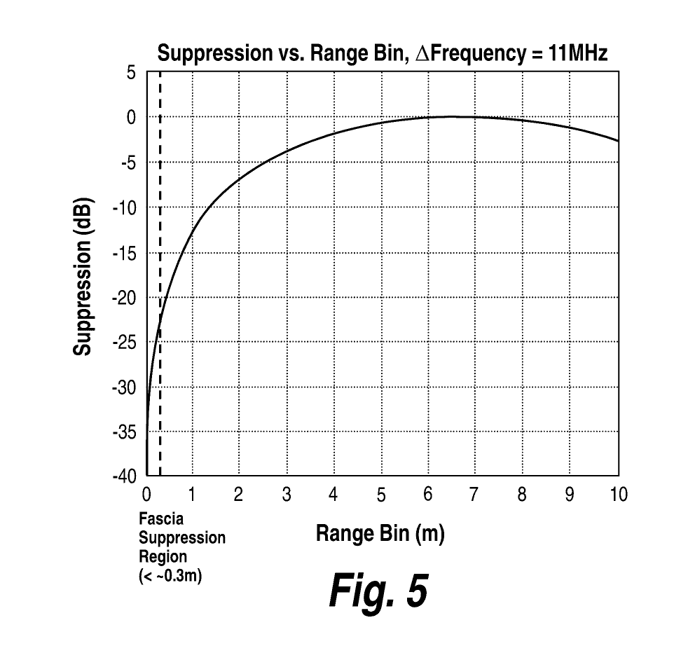

FIG. 5 is a graph of suppression (attenuation) versus range bin. As shown in FIG. 5, suppression at the range of the fascia, i.e., less than 0.3 meter in range, is substantial, whereas, at a range of approximately 6.8 meters, suppression is zero.

It should also be noted that the relative durations of the events depicted in the timing diagram of FIG. 3 are not to scale. For example, in some exemplary embodiments, the transmit pulse width is comparatively long, and the receive gate duration is comparatively short. In some particular exemplary embodiments, the transmit pulse width is approximately 120 ns, and the receive gate width is 8 ns.

In other exemplary embodiments, the attenuation behavior of the system can be tailored to particular performance requirements. As described in detail above, pulse radar systems such as the system described and claimed herein consider the presence of an object at a certain range or range bin, then at a slightly different range, typically either slightly nearer to or slight further from the radar. This is repeated bin-by-bin until the entire range of interest has been covered. According to the disclosure, a particular frequency offset can be chosen for each range bin in order to control attenuation of undesired versus desired objects in each range bin. The maximum attenuation is normally at zero range, while the fascia is usually present at a slightly different range. According to some exemplary embodiments, phase rotations of one of the received signal parts can be introduced to move the maximum attenuation to any desired range. Also, according to some exemplary embodiments, transmit pulses can be transmitted with more than one frequency offset, e.g., 10 MHz and 20 MHz. In this case, the complex subtraction can be performed on different pairs, depending on the range of the object to be detected. According to exemplary embodiments, by appropriate choice of the frequency offsets and chosen pairs, attenuation of selected object signals can be minimized at particular ranges of interest.

Whereas many alterations and modifications of the disclosure will no doubt become apparent to a person of ordinary skill in the art after having read the foregoing description, it is to be understood that the particular embodiments shown and described by way of illustration are in no way intended to be considered limiting. Further, the subject matter has been described with reference to particular embodiments, but variations within the spirit and scope of the disclosure will occur to those skilled in the art. It is noted that the foregoing examples have been provided merely for the purpose of explanation and are in no way to be construed as limiting of the present disclosure.

While the present inventive concept has been particularly shown and described with reference to exemplary embodiments thereof, it will be understood by those of ordinary skill in the art that various changes in form and details may be made therein without departing from the spirit and scope of the present inventive concept as defined by the following claims.

1. A radar system, comprising:
a radar signal transmitter for transmitting transmitted radar signals into a region, a first transmitted radar signal having a first frequency and a second transmitted radar signal having a second frequency different from the first frequency;
a receiver for receiving reflected radar signals generated by reflection of the transmitted radar signals and generating receive signals indicative of the reflected radar signals, a first receive signal being indicative of a first reflected radar signal generated by reflection of the first transmitted radar signal, and a second receive signal being indicative of a second reflected radar signal generated by reflection of the second transmitted radar signal;
a processor receiving the first and second receive signals and computing a difference between the first and second receive signals to generate a difference signal, the processor processing the difference signal to provide radar information for the region.

2. The radar system of claim 1, wherein a difference between the first frequency and the second frequency is selected such that the information related to objects in the region near the radar system is attenuated in the difference signal.

3. The radar system of claim 1, wherein a difference between the first frequency and the second frequency is selected such that a phase difference between the first and second reflected radar signals is such that information related to objects in the region near the radar system is attenuated in the difference signal.

4. The radar system of claim 1, wherein the first frequency is approximately 24.2 GHz.

5. The radar system of claim 1, wherein a difference between the first frequency and the second frequency is approximately 11 MHz.

6. The radar system of claim 1, wherein the transmitted radar signals are pulse radar signals.

7. The radar system of claim 6, wherein a pulse of the pulse radar signals has a duration of approximately 120 nsec.

8. The radar system of claim 1, wherein the radar system is an automotive radar system.

9. The radar system of claim 8, wherein a difference between the first frequency and the second frequency is selected such that information related to objects in the region near the radar system is attenuated in the difference signal.

10. The radar system of claim 9, wherein the objects in the region near the radar system include a bumper fascia of an automobile in which the radar system is disposed.

11. The radar system of claim 8, wherein a difference between the first frequency and the second frequency is selected such that a phase difference between the first and second reflected radar signals is such that information related to objects in the region near the radar system is attenuated in the difference signal.

12. The radar system of claim 8, wherein the radar system is an automotive blind spot radar system.

13. A detection method in a radar system, comprising:
transmitting transmitted radar signals into a region, a first transmitted radar signal having a first frequency and a second transmitted radar signal having a second frequency different from the first frequency;
receiving reflected radar signals generated by reflection of the transmitted radar signals;
generating receive signals indicative of the reflected radar signals, a first receive signal being indicative of a first reflected radar signal generated by reflection of the first transmitted radar signal, and a second receive signal being indicative of a second reflected radar signal generated by reflection of the second transmitted radar signal;
computing a difference between the first and second receive signals to generate a difference signal; and
processing the difference signal to provide radar information for the region.

14. The method of claim 13, further comprising selecting a difference between the first frequency and the second frequency such that information related to objects in the region near the radar system is attenuated in the difference signal.

15. The method of claim 13, further comprising selecting a difference between the first frequency and the second frequency such that a phase difference between the first and second reflected radar signals is such that information related to objects in the region near the radar system is attenuated in the difference signal.

16. The method of claim 13, wherein the first frequency is approximately 24.2 GHz.

17. The method of claim 13, wherein a difference between the first frequency and the second frequency is approximately 11 MHz.

18. The method of claim 1, wherein the transmitted radar signals are pulse radar signals.

19. The method of claim 18, wherein a pulse of the pulse radar signals has a duration of approximately 120 nsec.

20. The radar system of claim 1, wherein the radar system is an automotive radar system.

21. The method of claim 20, further comprising selecting a difference between the first frequency and the second frequency such that information related to objects in the region near the radar system is attenuated in the difference signal.

22. The method of claim 21, wherein the objects in the region near the radar system include a bumper fascia of an automobile in which the radar system is disposed.

23. The method of claim 20, further comprising selecting a difference between the first frequency and the second frequency such that a phase difference between the first and second reflected radar signals is such that information related to objects in the region near the radar system is attenuated in the difference signal.

24. The method of claim 20, wherein the radar system is an automotive blind spot radar system.
